(19) United States
(12) Patent Application Publication
(10) Pub. No.: US 2007/0183826 A1
(43) Pub. Date: Aug. 9, 2007

(54) MULTI-FUNCTION PRINTER

(75) Inventor: Xiao Jun Liu, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/671,361

(22) Filed: Feb. 5, 2007

(30) Foreign Application Priority Data
Feb. 6, 2006 (TW) TW95103898

(51) Int. Cl. G03G 15/00

(52) U.S. Cl. 399/380

(57) ABSTRACT

A multi-function printer comprises a printing module having a channel and an accommodation portion with a lateral wall, a scanning module rotatably disposed on the printing module, a guiding element disposed in the accommodation portion and adjacent to the lateral wall and moving between a first position and a second position, and a supporter with one end disposed on the scanning module and the other end slidably disposed in the channel through the guiding element. When the scanning module is opened to a predetermined angle, the supporter slides from the channel to be positioned between the guiding element and the lateral wall. When the scanning module is closed, the scanning module is further opened to move the guiding element to the second position. The scanning module descends and the supporter is guided by the guiding element into the channel.

### BACKGROUND OF THE INVENTION

1. Field of the Invention

The invention relates to a multi-function printer, and in particular to a multi-function printer having a supporter and its scanning module can be operated by a single hand.

2. Description of the Related Art

Referring to FIG. 1a, a conventional multi-function printer 10 comprises a scanning module 5 and a printing module 7. The scanning module 5 is rotatably disposed on the printing module 7. In FIG. 1b, the scanning module 5 is open. When the scanning module 5 is open, a supporter 6 engages a groove (not shown) in the printing module 7, whereby the scanning module 5 is supported and positioned on the printing module 7. When the scanning module 5 is about to be closed, the scanning module 5 must be held by one hand and the supporter 6 pulled from the groove by the other hand. In such a structure, the scanning module 5 is closed by two hands. In such a condition, the operation is complicated and may cause security problem. When improperly operated, the hand holding the supporter 6 may be hurt by the falling scanning module 5.

### BRIEF SUMMARY OF THE INVENTION

An embodiment of a multi-function printer of the invention comprises a printing module having a channel and an accommodation portion with a lateral wall, a scanning module rotatably disposed on the printing module, a guiding element disposed in the accommodation portion and adjacent to the lateral wall and moving between a first position and a second position, and a supporter with one end disposed on the scanning module and the other end slidably disposed in the channel through the guiding element. When the scanning module is opened to a predetermined angle, the supporter slides from the channel to be positioned between the guiding element and the lateral wall. When the scanning module is closed, the scanning module is further opened to move the guiding element to the second position. The scanning module descends and the supporter is guided by the guiding element into the channel. When the scanning module is completely closed, the guiding element returns the first position. The channel has an opening on the lateral wall.

The guiding element has a depression adjacent to the lateral wall and having a curved surface. When the guiding element is in the first position, the curved surface and the lateral wall form a space where the supporter is positioned between the guiding element and the lateral wall. When the guiding element is in the second position, the curved surface is connected with the opening, whereby the supporter is guided by the depression to enter the channel.

The guiding element has at least one protrusion, and the accommodation portion has a first groove and a second groove corresponding to the first position and the second position. When the guiding element is in the first position, the protrusion engages the first groove to position the guiding element in the first position. When the guiding element moves from the first position to the second position, the protrusion escapes from the first groove and engages the second groove to position the guiding element in the second position.

The guiding element has a engaging element, and the accommodation portion further has a third groove, and when the guiding element is in the first position, the engaging element engages the third groove, whereby the guiding element is positioned in the first position.

The guiding element further has a switch disposed on the curved surface and connected to the engaging element. When the supporter enter the space, the supporter abuts the depression to actuate the switch, whereby the engaging element escapes from the third groove.

The switch has a notch, and the supporter has a tongue. When the supporter enters the space, the tongue engages the notch to actuate the switch, whereby the engaging element escapes from the third groove.

The engaging element has an inclined surface guiding the engaging element to leave the third groove and abut the lateral wall of the accommodation portion.

The elastic element can be an elastic plate or a spring. The elastic element, the protrusion and the guiding element can be formed integrally.

### BRIEF DESCRIPTION OF THE DRAWINGS

The invention can be more fully understood by reading the subsequent detailed description and examples with references made to the accompanying drawings, wherein:

FIGS. 1a and 1b are schematic views of a conventional multi-function printer;

FIGS. 2˜8 depict the operation of an embodiment of a multi-function printer of the invention;

FIG. 9 is a perspective view of the guiding element of the multi-function printer of the invention;

FIG. 10 is a perspective view of the accommodation portion of the multi-function printer of the invention;

FIG. 11 is a perspective view of the supporter of the multi-function printer of the invention;

FIGS. 12, 13 and 14 depict that the supporter releases the guiding element from the first position;

FIGS. 15 and 16 depict the structure of the engaging element of the invention; and

FIG. 17 is a perspective view of another embodiment of the protrusion of the multi-function printer of the invention.

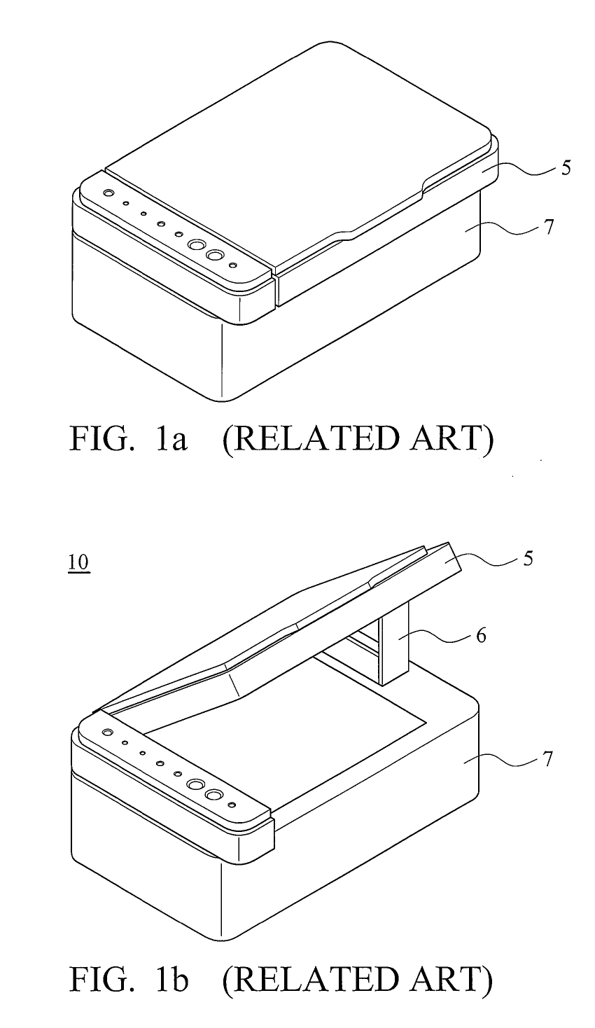

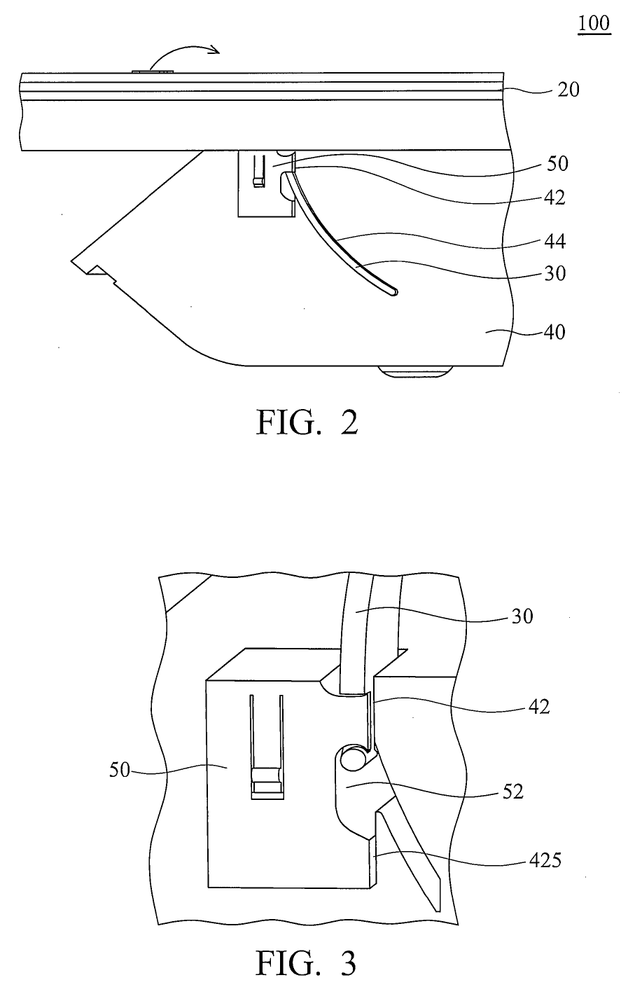

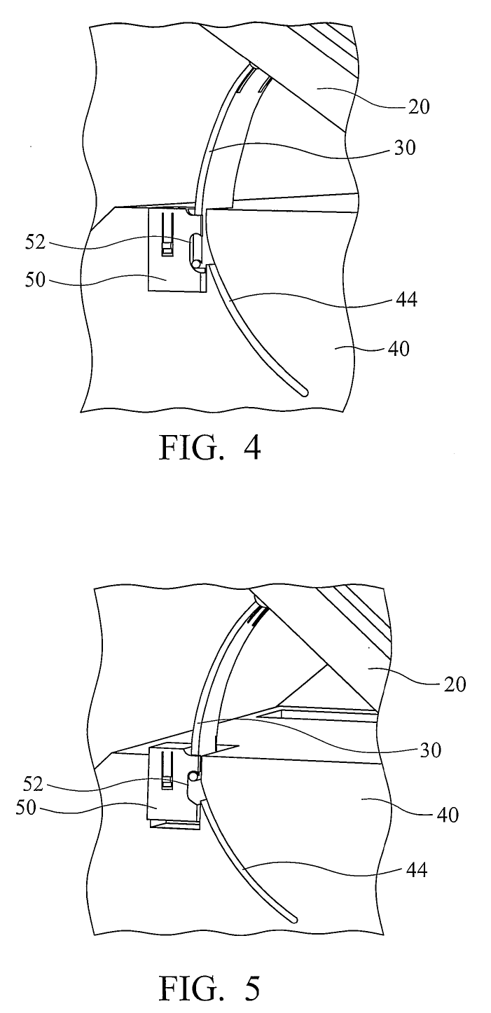

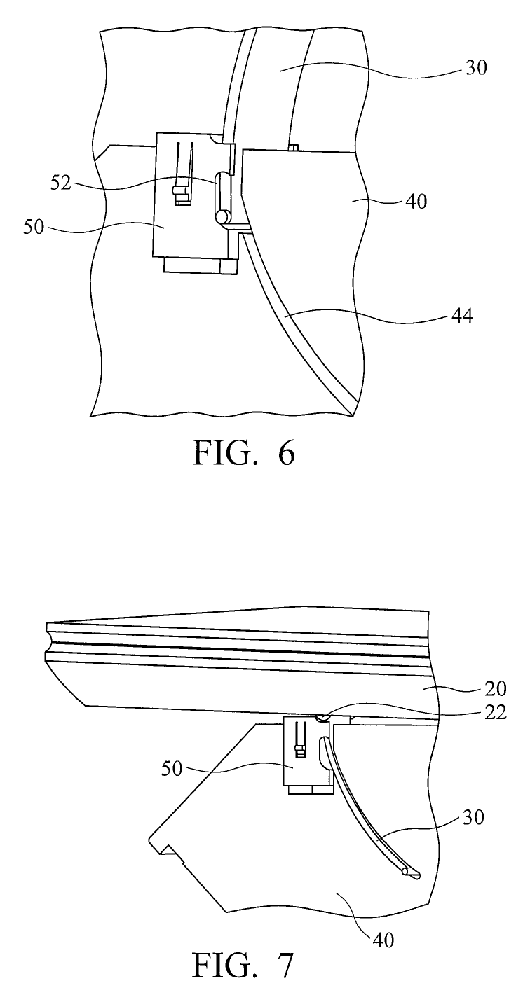

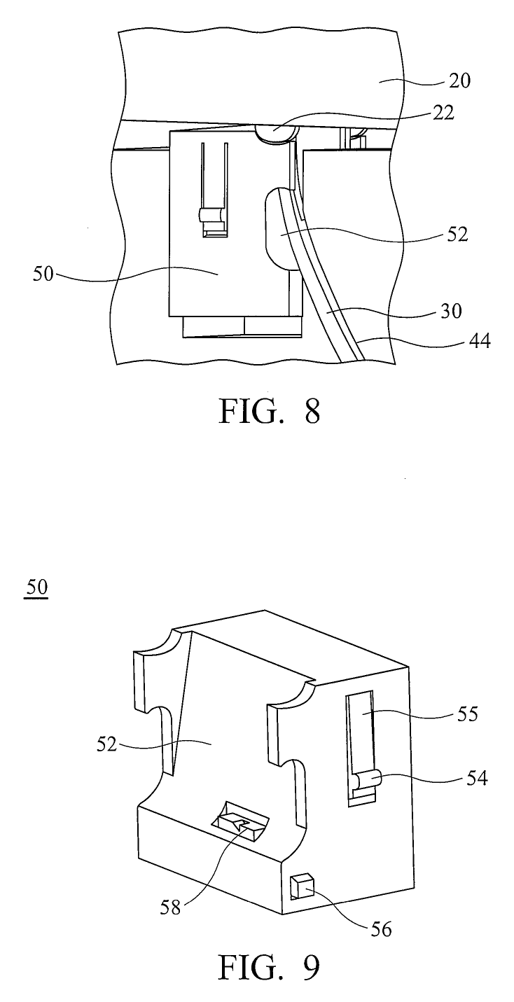

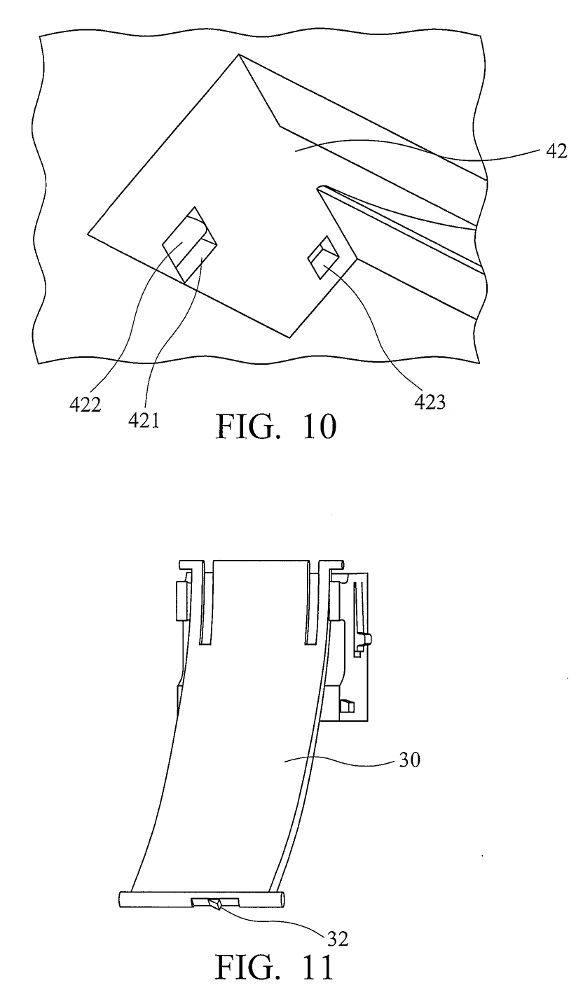

### DETAILED DESCRIPTION OF THE INVENTION

FIGS. 2 to 8 depict the operation of a multi-function printer of the invention by one hand. Elements of the multi-function printer are described in advance. Referring to FIG. 2, the multi-function printer 100 comprises a scanning module 20, a supporter 30, a printing module 40 and a guiding element 50. The scanning module 20 is rotatably disposed on the printing module 40. The printing module 40 comprises an accommodation portion 42 and a channel 44. The channel 44 is curved and has an opening on a lateral wall 425 of the accommodation portion 42 (see FIG. 3). The guiding element 50 is slidably disposed in the accommodation portion 42 and capable of moving between a first position and a second position. The guiding element 50 has a depression 52 adjacent to the lateral wall 425 and facing the opening of the channel 44. FIG. 2 shows the guiding element 50 in the first position. The supporter 30 is a curved element with one end connected to the scanning module 20 and the other end extending through the depression 52 and slidably disposed in the channel 44. When the scanning module 20 is closed, the supporter 30 is accommodated in the channel 44 as shown in FIG. 2. When the scanning module 20 is opened, the supporter 30 slides out of the channel 44 to abut the depression 52. At this time, the guiding element 50 is positioned in the first position and constrains the supporter 30, whereby the scanning module 20 is stopped as shown in FIG. 3. The scanning module 20 descends, and the supporter 30 enters and is positioned in a space formed by the depression 52 and the lateral wall 425, whereby the scanning module 20 is supported on the printing module 40 as shown in FIG. 4.

When the scanning module 20 is about to be closed, the scanning module 20 is further lifted. At this time, the supporter 30 pulls the guiding element 50 up to the second position where a curved portion of the depression 52 is aligned with the opening of the channel 44 to form a guiding path as shown in FIG. 5. When the scanning module 20 descends, the supporter 30 slides through the depression 52 and enters the channel 44 as shown in FIGS. 6 and 7. When the scanning module 20 is about to be closed completely, a protrusion 22 on the scanning module 22 pushes the guiding element 50 down to the first position as shown in FIG. 8. At this time, the supporter 30 is accommodated in the channel 44 as shown in FIG. 2.

The most critical steps are shown in FIGS. 3, 4 and 5. In FIG. 3, when the supporter 30 moves upward, the guiding element 50 is fixed and constrains the supporter 30. In FIG. 5, however, when the supporter 30 is further lifted, the guiding element 50 is pulled to the second position by the supporter 30, whereby the curved portion of the depression 52 is aligned with the channel 44. The steps are described in detail as follows.

FIG. 9 depicts a perspective view of the guiding element 50. FIG. 10 depicts a perspective view of the accommodation portion 42. The guiding element 50 has a protrusion 54 and an engaging element 56. In the embodiment, the protrusion 54 is disposed on an elastic plate 55. One end of the elastic plate 55 is connected to the guiding element 50, whereby the protrusion 54 can move on the lateral side together with the guiding element 50, and the engaging element 56 is retractable on the lateral side of the guiding element 50. Correspondingly, the accommodation portion 42 has a first groove 421, a second groove 422 and a third groove 423. When the guiding element 50 is disposed in the accommodation portion 42, the protrusion 54 engages the first groove 421 and the second groove 422 to position the guiding element 50 in the first position and the second position respectively. The engaging element 56 can engage the third groove 423. In the embodiment, the protrusion 54, elastic plate 55 and the guiding element 50 are formed integrally.

Referring to FIG. 3 again, when the guiding element 50 is in the first position, the protrusion 54 is engaged with the first groove 421 by the elastic plate 55. At this time, the engaging element 56 projects from the guiding element 50 to engage the third groove 423 so as to fixed the guiding element 50 in the first position, whereby the guiding element 50 limits the supporter 30.

When the supporter 30 descends to the space as shown in FIG. 4, the supporter 30 abuts the depression 52 to draw the engaging element 56 back. When the supporter 30 is pulled up again, the guiding element 50 is pulled to the second position by the supporter 30 as shown in FIG. 5.

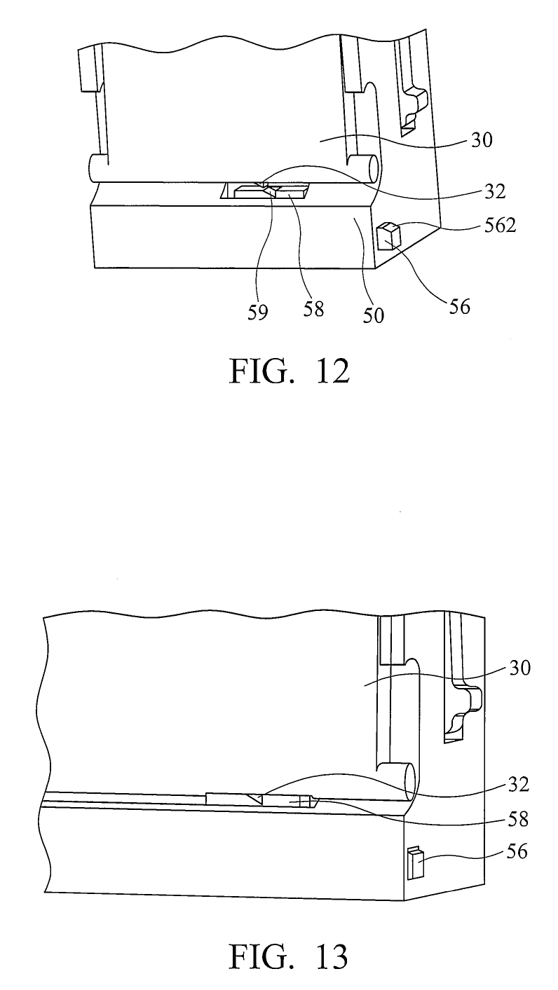

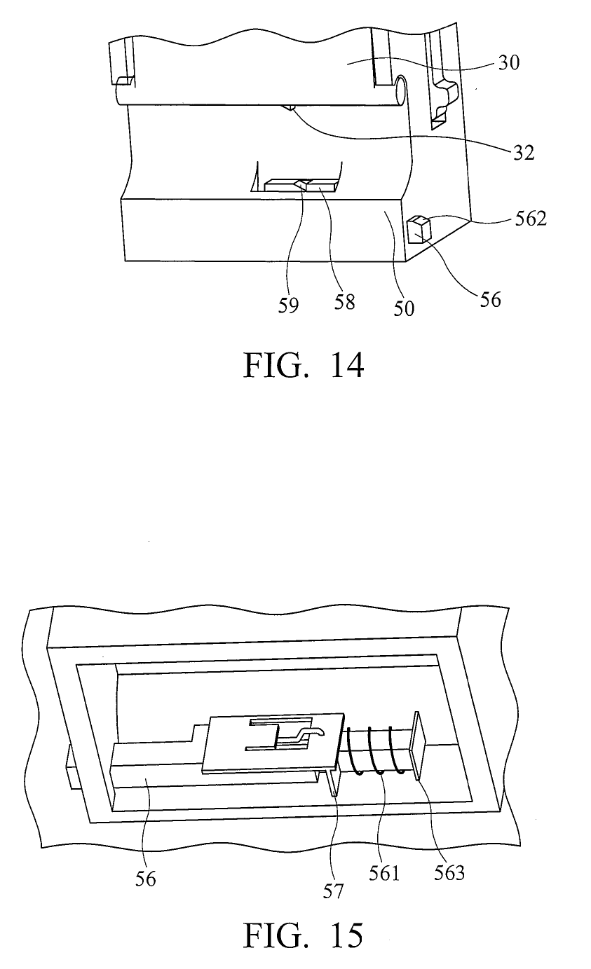

FIGS. 4 and 5 are described in detailed as follows. In FIG. 9, the guiding element has a switch 58 disposed in the depression 52. The switch 58 is connected to the engaging element 56. A notch 59 is formed on the switch 58, and a tongue 32 is disposed on the front of the supporter 30 as shown in FIG. 11. Referring to FIGS. 12, 13 and 14, when the supporter 30 descends and abuts the depression 52, the tongue 32 engages the notch 59 and pulls the switch 58 to left, whereby the engaging element 56 is drawn back. With an inclined surface 562 on the engaging element 56 and the lateral side of the guiding element 50, when the supporter 30 is pulled up again; the guiding element 50 is moved to the second position as shown in FIG. 5.

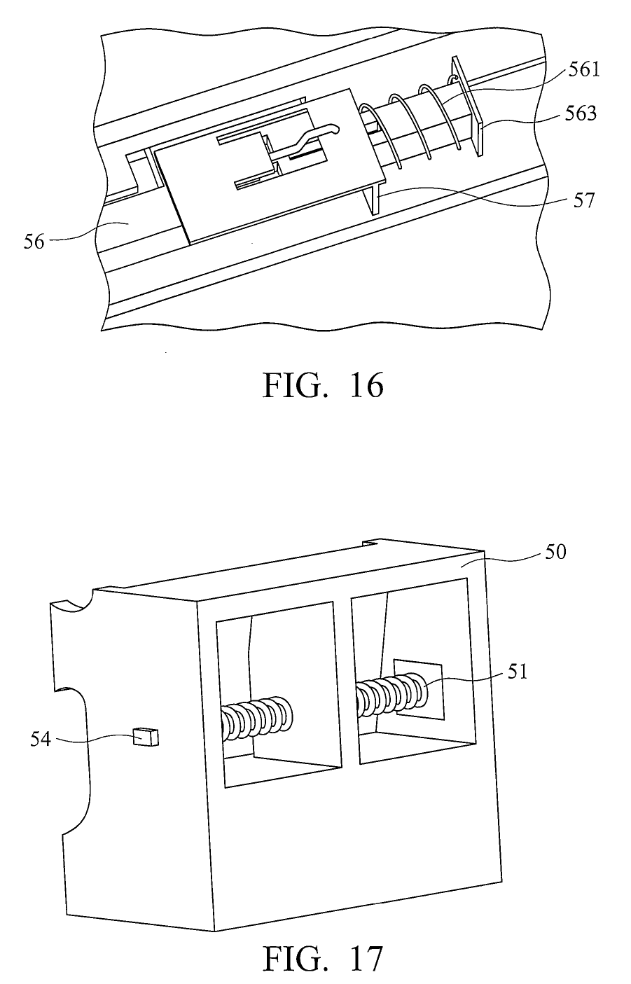

The structure of the engaging element 56 is shown in FIGS. 15 and 16. The engaging element 56 is a column-shaped. The spring 561 engages between a holder 57 and a limiting element 563. The limiting element 563 is formed with the engaging element 56 integrally. The holder 57 is joined to the guiding element 50 to provide biasing force for the engaging element 56 to abut the lateral side of the accommodation portion.

FIG. 17 depicts another embodiment of the protrusion 54. In addition to the elastic plate, a spring can also be used to push the protrusion 54, whereby the protrusion 54 engages the first and second grooves 421 and 422.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multi-function printer, comprising:
a printing module having a channel and a accommodation portion with a lateral wall;
a scanning module rotatably disposed on the printing module;
a guiding element disposed in the accommodation portion and adjacent to the lateral wall and moving between a first position and a second position; and
a supporter with one end disposed on the scanning module and the other end slidably disposed in the channel through the guiding element, wherein when the scanning module is opened to an predetermined angle with respect to the printing module, the supporter slides from the channel to be positioned between the guiding element which is in the first position and the lateral wall, and when the scanning module is about to be closed, the scanning module is further opened to move the guiding element to the second position, and the scanning module descends and the supporter is guided by the guiding element into the channel, and when the scanning module is completely closed, the guiding element returns the first position.

2. The multi-function printer as claimed in claim 1, wherein the channel has an opening on the lateral wall.

3. The multi-function printer as claimed in claim 2, wherein the guiding element has a depression adjacent to the lateral wall and having a curved surface, and when the guiding element is in the first position, the curved surface and the lateral wall form a space where the supporter is positioned between the guiding element and the lateral wall, and when the guiding element is in the second position, the curved surface is connected with the opening, whereby the supporter is guided by the depression to enter the channel.

4. The multi-function printer as claimed in claim 3, wherein the guiding element has at least one protrusion, and the accommodation portion has a first groove and a second groove corresponding to the first position and the second position, and when the guiding element is in the first position, the protrusion engages the first groove to position the guiding element in the first position, and when the guiding element moves from the first position to the second position, the protrusion escapes from the first groove and engages the second groove to position the guiding element in the second position.

5. The multi-function printer as claimed in claim 4, wherein the guiding element has a engaging element, and the accommodation portion further has a third groove, and when the guiding element is in the first position, the engaging element engages the third groove, whereby the guiding element is positioned in the first position.

6. The multi-function printer as claimed in claim 5, wherein the guiding element further has a switch disposed on the curved surface and connected to the engaging element, and when the supporter enter the space, the supporter abuts the depression to actuate the switch, whereby the engaging element escapes from the third groove.

7. The multi-function printer as claimed in claim 6, wherein the switch has a notch, and the supporter has a tongue, and when the supporter enters the space, the tongue engages the notch to actuate the switch, whereby the engaging element escapes from the third groove.

8. The multi-function printer as claimed in claim 5, wherein the engaging element has an inclined surface guiding the engaging element to leave the third groove and abut the lateral wall of the accommodation portion.

9. The multi-function printer as claimed in claim 4, wherein the guiding element has at least one elastic element joined to the protrusion, whereby the protrusion engages or leave the first and second grooves.

10. The multi-function printer as claimed in claim 9, wherein the elastic element is an elastic plate.

11. The multi-function printer as claimed in claim 10, wherein the elastic element, the protrusion and the guiding element are formed integrally.

12. The multi-function printer as claimed in claim 9, wherein the elastic element is a spring.
